(19) United States
(12) Patent Application Publication
(10) Pub. No.: US 2007/0283744 A1
(43) Pub. Date: Dec. 13, 2007

(54) Surface friction measuring device

(76) Inventors: Kenneth John Balkwill, Hull (GB); Ronald Frederick Hopkins, Radstock (GB)

Correspondence Address: PAUL E MILLIKEN, 9061 WALL ST NW, MASILLON, OH, 44646-1676, US

(21) Appl. No.: 11/799,769

(22) Filed: May 2, 2007

(30) Foreign Application Priority Data
Nov. 3, 2004 (GB) 0424324.2

(51) Int. Cl. G01N 19/02

(52) U.S. Cl. 73/9

(57) ABSTRACT

A method of measuring surface friction in which drag due to contaminant lying on a said surface can be isolated, and a continuous friction measuring device for effecting the measurement. The device has a pair of friction measuring wheels (36,37) in contact with the ground and a third wheel (41) which is freely rotatable during the friction measuring process, the axle (42) of the third wheel (41) being provided with a load sensor (55) to measure the horizontal drag load on the third wheel during the friction measuring process. A trailer or vehicle incorporating the wheels (36, 37, 41) is passed through contaminant lying on a surface and the horizontal drag on the wheel (41) is measured simultaneously with a continuous measurement of the friction coefficient of said surface.

### FIELD

This invention relates to a method of measuring a drag component during continuous measuring of surface friction and a device for measuring and reporting drag and friction of a surface such as a runway, taxiway, or road, and is particularly for use within air ports.

### BACKGROUND OF THE INVENTION

Friction meters for use in measuring the friction of aircraft runways are well known. One well known friction meter is available from Douglas Equipment Ltd under the trade name MU-Meter and comprises a small three wheeled trailer that is towed along the surface to be measured. The meter has a chassis comprises a two main side members pivoted relative to each other at the forward end with each side member supporting a wheel which is biased at a toe-out angle to the direction of travel. The two wheels are biased oppositely to each relative to the direction of travel of the trailer and the friction is related to the force pushing the wheels apart at particular speeds.

A third wheel for measuring distance run is supported on another arm pivoted to the chassis.

The trailer incorporates electronic measuring systems which operate in conjunction with a computer carried in a chosen towing vehicle. The trailer systems produce signals which may be presented on a lap top screen and processed for later downloading. Additionally or alternatively the recorded data can be exported.

Other known runway friction meters are disclosed in GB-1366947 in which a wheel is mounted on a torque coupling which is used to measure the co-efficient of friction of a road or runway as the wheel is run along a runway surface so as to slip. A similar system is disclosed in U.S. Pat. No. 4,958,512 in which the forces acting on a braked wheel are measured.

Another known meter is disclosed in WO0036397 in which a single wheel is run at a bias to the direction of travel and the friction acting between the tread and runway surface is measured and recorded.

A problem with existing surface friction measuring devices is that they do not accurately reflect the friction of a surface covered by a contaminant for example, in extreme weather conditions, a runway may be covered in water, snow, slush, and or ice. In such conditions, the friction measuring meters can give false readings caused by contaminant drag on the friction measuring wheel. This drag force may aid some aircraft landings but it considerably lengthens take-off lengths

The present invention seeks to provide a friction meter which is also capable of recording the drag force exerted by contaminant lying on a surface such as a road or runway.

### STATEMENTS OF INVENTION

According to a first aspect of the invention there is provided a continuous friction measuring device having two friction measuring wheels in contact with the ground and a third wheel which is freely rotatable during the friction measuring process, the axle of the third wheel being provided with a load sensor to measure the horizontal drag load on the third wheel during the friction measuring process.

Preferably, the load cell is two axis load cell for measurement of both vertical and horizontal loads acting on the third wheel. The wheel may be mounted on a stub axle which is mounted on a load sensor. A load sensor may comprise a metal block, steel, incorporating strain gauges.

The measuring device may comprise a chassis including two main side members pivoted together at the front end thereof each with a respective friction measuring wheel mounted thereon, said third wheel being mounted on a suspension arm pivoted to the chassis between said two friction measuring wheels.

The device may further comprise a three axis accelerometer mounted at the centre of gravity of the device.

According to a second aspect of the invention there is provided a method of measuring surface friction in which drag due to contaminant lying on a said surface can be isolated, wherein in said method, a trailer or vehicle having a freely rotating wheel in contact with the surface, is passed through the contaminant and the horizontal drag on the wheel is measured simultaneously with a continuous measurement of the friction coefficient of said surface.

In said method the loads acting on the freely rotating wheel are measured in both horizontal and vertical directions.

The load on the wheel is measured as a load exerted on the wheel axle.

In said method, the drag force drag force may be measured for a series of known depths of contaminant and subsequent drag readings may then be used to define the contaminant depth and other physical property ( for example with snow) through which the trailer may travel. The drag measurement taken on a dry surface and then at different water depths will also allow the textured depth of a runway to be calculated

A method of measuring pitch, yaw, and roll may be provided by the installation of a three axes accelerometer which may be installed at the centre of gravity of the trailer to sense the three components of acceleration and angles of inclination.

### DESCRIPTION OF THE DRAWINGS

The invention will be described by way of example and with reference to the following drawings in which:

FIG. 1 is an isometric view of a friction meter according to the present invention in tow behind a vehicle,

FIG. 2 is a plan view of the chassis of the friction meter shown in FIG. 1,

FIG. 3 is a side view of the friction meter chassis,

FIG. 4 is a plan view of the central wheel suspension arm,

FIG. 5 is a side view of the suspension arm shown in FIG. 4, and

FIG. 6 is a graph of the friction and drag measurements made by the apparatus according to the present invention.

### DETAILED DESCRIPTION OF THE INVENTION

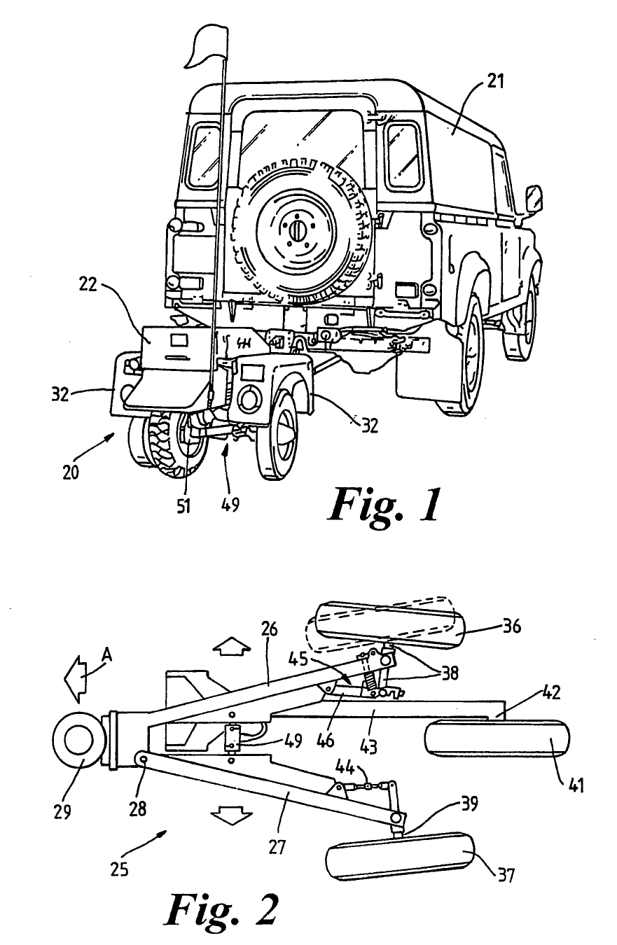

With reference to FIG. 1 there is shown a runway friction meter 20 in the form of a three wheeled trailer which is towed behind a chosen vehicle 21. The friction meter 20 is of the type known as runway continuous friction measuring equipment and incorporates electronic measuring and control systems housed in a central control unit 22 on the top of the trailer which produce signals which are passed to a processor, typically a lap top computer carried in the tow vehicle 21. The friction meter 20 will be described in sufficient detail for an understanding of the present invention.

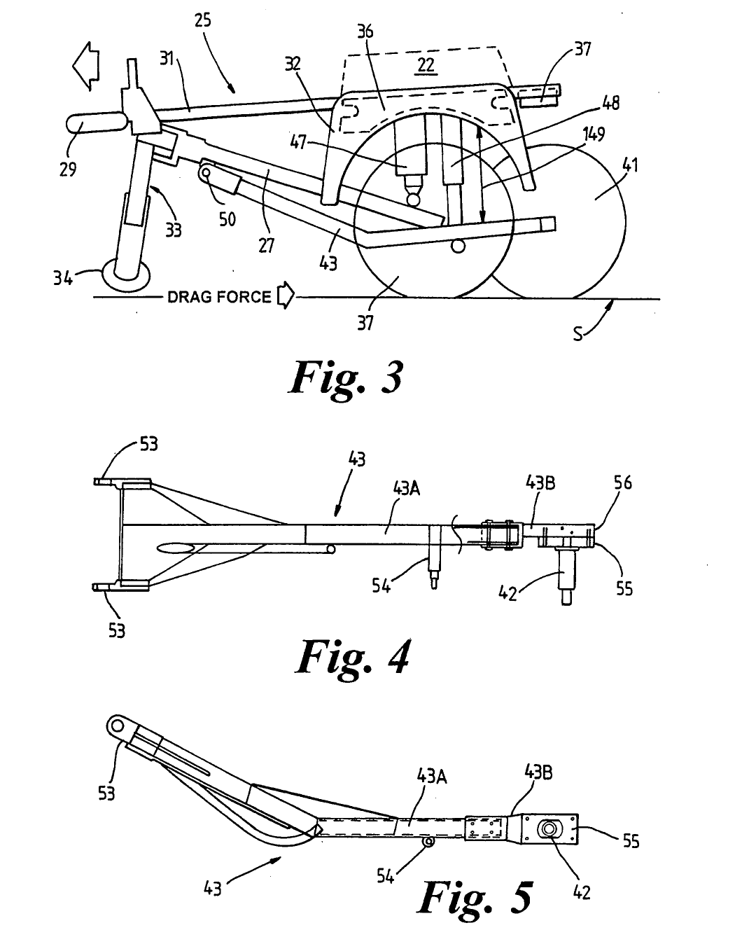

Referring additionally to FIGS. 2-5, the trailer 20 comprises a fabricated steel chassis 25 including two main side members 26, 27 pivoted together at the front end of the trailer by pivot pin 28. The chassis 25 also includes a top frame 31 which supports the control unit 22 with its cover and mudguards 32. The two mudguards 32 may incorporate ballast weights 36 and a further ballast weight 37 is secured to the top frame 31 behind the control unit 22. The two side members 26, 27 each have a respective wheel 36, 37 mounted thereon via a respective stub axle 38,39 located at the rear end portion of each side member. A rear wheel 41 is mounted on a suspension arm 43 via a respective stub axle 42. The suspension arm 43 is pivoted to the front end portion of the right hand side member 26 by a shaft 50.

The two side member wheels 36, 37 are used for friction measuring and both comprise a pneumatic tyre with a smooth tread. The left hand wheel 37 is locked to a pre-set toe out relative to the trailer fore-and-aft centre line by means of an adjuster 44. The right hand wheel 36 is linked to a wheel positioning system 45 which allows castoring between transit and measuring positions. The transit position is shown in broken line. The wheel 36 is castored by means of a lever 46 acting on the stub axle 38. The friction loads acting on the wheels 36, 37 are measured by a load cell 49 extending between the two side members 26,27. The rear wheel 41 has a treaded tyre and in use stabilises the trailer and is use for measuring the distance travelled.

A pair of fluid damped shock absorbers 47act between each side member 26,27 and the top frame 3 Ito absorb road / runway surface shocks. A single non damped spring strut 48 acts between the top frame 31 and the suspension arm 43 to maintain the rear wheel 41 in constant contact with the road surface S. The rear wheel 41 may be lifted when not in use. To this end, an actuator 49, preferably a 12v DC linear actuator, acts between the chassis 25 and the suspension arm 43. The lifting of the wheel is controlled by the control unit 22.

In use, the trailer is towed along a road/runway surface with the two side wheels toed-out at about 7.5 degrees of arc to the direction of travel of the trailer as shown by arrow A. The distance run by the trailer 20 is measured by a distance sensor 51 mounted adjacent the rear wheel 41, for example a photo electric shaft revolution encoder. The surface friction is derived from the load cell 49 which measures the loads acting on the wheels 36, 37 tending to push the two wheels 36 and 37 apart. The central control unit 22 receives the information from the sensors 49 & 51 and this is converted to digital and conditioned to give actual friction and distance readings, as is well known in the art.

The suspension arm 43 is shown in detail in FIG. 4 and FIG. 5. The front end of the arm 43 has a forked end with a pair of lugs 53 for pivotal attachment to the right hand side member 26. The stub axle 42 is located at the other end of the arm 43 and a suspension stud 54 for attachment of the spring strut 48 is provided at an intermediate location. The suspension arm 43 comprises a front portion 43A extending rearwardly from the forked end to beyond the suspension stud 54, and a rear portion 43B on which the stub axle 42 is mounted and which is a slide fit over the rear end on the front portion 43A. The stub axle 42 is mounted on a two axis load cell 55 which in turn is secured to a block 56 which form part of the rear portion 43A of the arm.

In an alternative arrangement, the arm 43 could comprise a unit construction with the load cell 55 secured directly to the rear end of the one piece arm. The load cell will measure vertical deflections due to surface variation on the road or runway and the horizontal deviations due to drag. The load cell 55 will be connected into the control unit 22 and can be calibrated whilst calibrating the friction measuring sensor 49.

The front end of the chassis 25 is provided with a suitable towing hitch 29 in this example a towing ring but other forms of hitch may be used and a downwardly extending support leg 33 which is removably connected to the front end of the chassis by for example a quick release pin (not shown). A jockey wheel 34 may be mounted on the support leg 33 to assist man handling the trailer 20.

When measuring friction and drag, the trailer 20 is towed along the surface to be measured with the right hand wheel 36 toed out at 7.5 degrees of arc and the rear wheel 41 is lowered to contact the ground with the spring strut 48 exerting a sufficient downward load to maintain contact with the road surface S. As the trailer proceeds in measuring mode the friction generated between the side wheel tyres and the runway is measured by the load cell 49, and simultaneously the horizontal and vertical loads acting on the rear wheel 41 are measured by the load cell 55.

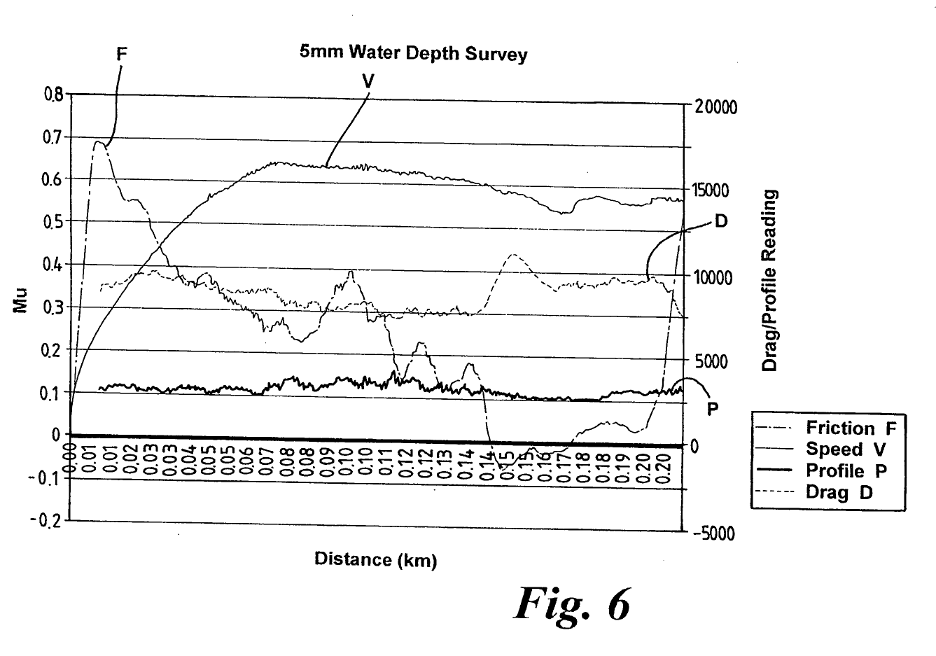

The signals from the sensors 49, 51, and 55 are processed by the control unit 22 and a lap top computer in the vehicle 21 to produce a read out chart or graph which is shown in FIG. 6. With reference to FIG. 6 there is shown a read out produced by the software in the computer in the vehicle 21 and which has a horizontal axis representing distance run by the vehicle with a vertical axis representing friction, drag and vehicle stability or profile. The curves V represents vehicle speed or velocity, drag D, surface profile P and surface friction F. The test run is measured on an initially dry runway having a 5 mm depth of water (contaminant) after a run distance of 150 meters. The friction curve shows an increase in friction as the vehicle accelerates up to a selected test speed, for example 65 km/h. The friction falls until the vehicle speed reaches a steady state at about 70 meters and thereafter the friction is a true reading for a damp runway surface until the 5 mm standing water is hit at 150 m. The friction reading then falls rapidly to less than zero, illustrating that readings are unreliable. The drag curve D is substantially steady up to 150 m and begins to climb rapidly once the vehicle hits the 5 mm standing water. At the same time the vehicle speed V begins to fall more rapidly after 150 m. The profile curve P indicates the change in surface profile to a smooth surface as the wheel beings to aquaplane.

The system can discriminate against speed and water depth for depths of water which increase in 2 mm increments up to a maximum of 19 mm (¾ inch). This maximum depth can be approximately compared with 300 mm of snow.

The drag force reading could be used to define the water (or other contaminant) depth or a combination of depth and other physical property (for example with snow) through which the trailer is travelling. The drag measurement taken at different water depths will allow the textured depth of a runway to be calculated.

The algorithm within the software can make corrections for other exterior forces acting on the structure of the measuring device and which are not relevant to the drag calculation.

A three axes accelerometer may be installed at the centre of gravity of the trailer to sense the three components of acceleration and angles of inclination of the trailer to the surface, that is roll, pitch, and yaw.

What is claimed is:

1. A continuous friction measuring device having two friction measuring wheels in contact with the ground and a third wheel which is freely rotatable during the friction measuring process characterised in that the axle of the third wheel is provided with a load sensor to measure the horizontal drag load on the third wheel during the friction measuring process.

2. A device as claimed in claim 1 wherein the load cell is a two axis load cell for measurement of both vertical and horizontal loads acting on the third wheel.

3. A device as claimed in claim 2 wherein the wheel is rotatably mounted on a stub axle which is mounted on a load sensor.

4. A device as claimed in claim 3 wherein the load sensor may comprise a metal block incorporating strain gauges

5. A device as claimed in claim 1, and further comprising a chassis including two main side members pivoted together at the front end thereof each with a respective friction measuring wheel mounted thereon, and said third wheel is mounted on a suspension arm pivoted to the chassis between said two friction measuring wheels.

6. A device as claimed in claim 1 and further comprising a three axis accelerometer mounted at the centre of gravity of the device.

7. A method of measuring surface friction in which drag due to contaminant lying on a said surface can be isolated, wherein in said method a trailer or vehicle having a freely rotating wheel in contact with the surface is passed through the contaminant and the horizontal drag on the wheel is measured simultaneously with a continuous measurement of the friction coefficient of said surface.

8. A method according to claim 7, wherein the loads acting on the freely rotating wheel are measured in both horizontal and vertical directions.

9. A method as claimed in claim 7 wherein loads acting on the wheel are measured as a load exerted on the wheel axle.

10. A method as claimed in claim 7, wherein the drag force is measured for a series of known depths of contaminant to provide reference data, and subsequent drag readings may then be used in conjunction with the data to define contaminant depth.

11. A method as claimed in claim 10, wherein the drag force measurement taken on a dry surface and then at different water depths will also allow the textured depth of a runway to be calculated 12. A method as claimed in claim 7, wherein the three components of acceleration and the angle of inclination of the trailer are measured at the centre of gravity thereof to provide a measure of pitch, yaw, and roll of said trailer or vehicle.
